(19) United States
(12) Patent Application Publication
(10) Pub. No.: US 2009/0101281 A1
(43) Pub. Date: Apr. 23, 2009

(54) METHOD AND DEVICE FOR MANUFACTURING A LASER-INSCRIBABLE SMART LABEL

(76) Inventor: Klaus-Dieter Sacherer, Kirchheim (DE)

Correspondence Address: ROCHE DIAGNOSTICS OPERATIONS INC., 9115 Hague Road, Indianapolis, IN, 46250-0457, US

(21) Appl. No.: 12/256,933

(22) Filed: Oct. 23, 2008

(30) Foreign Application Priority Data
Oct. 23, 2007 (EP) 07119054.0

(51) Int. Cl. B32B 37/12

(52) U.S. Cl. 156/332; 156/378

(57) ABSTRACT

A method and device for manufacturing a radio-frequency label on an article is provided. The method generally comprises the steps of fixing at least one transponder on a surface of the article, the transponder comprising at least one radio-frequency chip and at least one antenna and at least one carrier film, and fixing at least one cover label on the transponder, the cover label comprising at least one inscribable surface directed away from the transponder.

### CLAIM OF PRIORITY

The present application is based on and claims priority to European Patent Application No. 07 119 054.0, filed Oct. 23, 2007, which is hereby incorporated by reference in its entirety.

### TECHNICAL FIELD OF THE INVENTION

The invention relates to methods and devices for the manufacture of a radio-frequency label. Such methods and devices can be used for identifying packages for test elements that are used for the detection of analytes in samples, for example for diagnostic test elements. However, it will be appreciated that the method according to the disclosed embodiments of the present invention and the device can also be used for other types of articles.

### BACKGROUND

Radio-frequency labels in the form of so-called smart labels, i.e. intelligent labels, are used in many areas of technology. Such labels generally comprise an RFID (Radio Frequency IDentification) system (identification via radio waves). Such RFID systems permit contactless read operations and/or write operations via radio waves. This means that the smart labels, in contrast to conventional labels, for example printed and purely optically readable labels, can be written with any desired information and without the need for touching the labels. Moreover, the labels can also be read out without direct visual contact between a reading device and the label. In addition, a visible surface of the smart label can of course also be inscribed, for example printed on or inscribed by a laser, in order to apply optically discernible information.

These properties of RFIDs and in particular of smart labels are exploited, for example, in the tracking of goods in the haulage industry, in products logistics, in the area of protection against theft, in the battle against counterfeit goods, or in other areas of technology and of everyday life. Thus, the US Food and Drug Agency recommends the use of RFID techniques in the battle against counterfeit medicines. Temperature-sensitive medical products are also often used with RFID labels with a sensor function on the transport containers. The recording can, for example, document a breach of transport conditions and can therefore protect patients against illegally transported pharmaceuticals or medical products.

The core features of smart labels, also referred to hereinbelow as radio-frequency labels, are the one or more transponders. Transponders, which are also known as RFID tags, are formed linguistically from a combination of the words “transceiver” and “responder”. Thus, transponders typically have a radio-frequency chip which, for example, can typically be configured as an analog circuit. This radio-frequency chip is usually configured to receive and send (transceive) data and also generally comprises a memory, for example a permanent (non-volatile) memory, which can be addressed via radio waves, i.e. via an antenna. Transponders are able to carry relatively large quantities of data (for example from a single bit to several kilobytes).

Transponders are known in various configurations. For example, so-called active transponders are known in which the transponder has its own energy source. More common, however, are so-called passive transponders, in which the transponder is supplied with energy via an external radio field (radio-frequency field). The following description focuses on the use of passive transponders, although active transponders can also be used.

Transponders also differ substantially in terms of frequency range. A normal frequency is the operating frequency of about 13.56 MHz according to ISO 15693. However, transponders are also known in other frequency ranges, for example in the range of between about 865 and about 869 MHz. Despite slightly different operating modes of these transponders for different frequency ranges, the frequencies are designated hereinbelow consistently as “radio-frequency”. The present application highlights the operating frequency of about 13.56 MHz solely for purposes of illustration and exemplary embodiments, but without thereby excluding the use of other frequencies.

In addition to having at least one radio-frequency chip which, as has been described above, can comprise one or more memories and/or one or more analog circuits, the transponders also may have at least one antenna. The antenna and the radio-frequency chip are usually mounted on a carrier film (which by analogy can also entail several films). The antenna and the radio-frequency chip are also often referred to together as an “inlay”. The carrier film with the inlay can in addition be protected by a covering layer (for example a protective paper layer and/or a PET film).

The antenna can, for example, have a coil with several windings, for example a copper coil and/or an aluminum coil. The antenna coil has the task of allowing data to be received from a reading device. Moreover, signals can also be transmitted to the reading device via the antenna. In the case of the passive transponders described above, a third function is the additional function of receiving energy, for example since a current can be induced in the transponder via the antenna, the electrical energy of which can be stored for example in a capacitor or another energy store.

Two ends of an antenna (several antennas can also be provided) are usually connected to the at least one radio-frequency chip. This radio-frequency chip (also referred to hereinafter as IC or chip) can contain all other component parts and thus, for example, can comprise the function of receiving energy and storing energy, transmitting and/or receiving data and/or storing data in a data memory.

As has been described above, radio-frequency labels can additionally have an inscribable surface, such that the radio-frequency labels can additionally be inscribed for data storage, also in a “conventional” manner, that is to say by means of a printing process for example.

Processes known hitherto from the prior art and used to manufacture radio-frequency labels generally comprise a large number of individual steps. At least four subsidiary steps are generally involved. In the first method step, the radio-frequency chip is manufactured, for example by means of a known semiconductor process. In a second method step separate from the manufacture of the radio-frequency chip, an antenna is usually manufactured. This can be done, for example, by an etching process performed on the carrier film, for example by etching of copper or aluminum in a reel-to-reel technique. In a third step, the radio-frequency chip is then connected to the antenna (bonding), for which various bonding methods can be used. For example, flip-chip techniques are possible here, and also techniques based on resistance welding, thermo-compression welding, crimp techniques or other kinds of connecting techniques or combinations of connecting techniques.

A fourth method step involves customization in which the smart labels are adapted to the respective use. Here, the transponder can be provided with a pressure-sensitive adhesive, for example, and can additionally be provided with an inscribable surface.

However, this large number of individual steps entails many disadvantages, which make the use of radio-frequency labels difficult in practice. Thus, a considerable disadvantage of the method is to be seen in the fact that the described process is extremely expensive and complex. Thus, a manufacturer of radio-frequency labels would have to employ techniques from the field of semiconductor technology, laminating techniques, bonding techniques, reel-to-reel technology, and printing or thick-film technology. Only a few manufacturers are able to offer all of these individual technologies, a fact which in general further complicates the logistics involved in the manufacture of the radio-frequency labels. Moreover, the described customization step, which is generally tailored to the particular customer, is relatively complex and additionally increases the costs of conventional methods.

A further disadvantage of known methods lies in the difficult quality control. Thus, particularly in the manufacture of the transponder and in the manufacture of the inscribable surfaces, faults may occur which generally become apparent only after the customization step, with the result that expensive radio-frequency labels that have already been customized often have to be rejected.

The object of the present invention is therefore to make available a method for the manufacture of a radio-frequency label on an article, which method at least substantially avoids the disadvantages of known methods. In particular, the method is intended to be inexpensive and to simplify the value chain in the production of radio-frequency labels.

### SUMMARY

This object is achieved by the invention with the features of the independent claims. Advantageous developments of the invention, which can be realized singly or in combination, are set forth in the dependent claims. The wording of all the claims is hereby made part of the content of the present description.

The basic method of the present invention is generally a two-stage method, in contrast to the known methods in which ready-customized transponder labels are affixed to surfaces. Additional stages not pertaining to the basic method of the present invention, e.g. additional steps for further refinement or other treatment of the resulting labels, are not necessarily beyond the scope of the invention. That is, the method comprising a generally two-stage method is intended as an inventive alternative to the basic four step method described above. Thus, any limitation to a particular number of steps or stages is only provided in the context of comparing the basic method of the prior art to the basic method being disclosed herein.

In a first stage of the method, at least one transponder is fixed on a surface of the article. This transponder can, for example, be configured with an inlay in accordance with the above description and has at least one radio-frequency chip and at least one antenna and at least one carrier film. As has been described above, the at least one radio-frequency chip can comprise, for example, at least one analog circuit and/or at least one data memory, such as a non-volatile data memory. For example, the at least one radio-frequency chip can be manufactured using conventional silicon technology or, alternatively or in addition, can also involve other manufacturing techniques. Thus, it is also possible in particular to use radio-frequency chips manufactured by polymer technology (i.e. using conductive and/or semiconductive polymers). This technology simplifies the manufacture of the transponder considerably, for example because no complicated flip-chip technology is needed for bonding the radio-frequency chip to the antenna. The antenna also can be manufactured using this technology, for example using conductive polymers. Hybrid technologies, for example technologies with organic radio-frequency chips and conventionally manufactured antennas, for example etched antennas, are also possible. In this connection, reference may be made to the above description of the known technologies. The manufacture of the transponder itself can be part of the proposed method, although it can also be realized in a separate manufacturing method, such that the transponder can be bought in.

In a second method step, a cover label is finally fixed on the carrier film, the cover label having at least one inscribable surface directed away from the carrier film.

Compared to the known manufacturing methods, in the proposed embodiment of the method the application of the transponder and the application of the cover label can take place separately. Transponder and cover label, which in both cases can be labels, can be procured, stored and handled separately from each other. Moreover, transponder and cover label can be applied separately from each other onto the same site on the surface of the article, for example in two separate automatic dispensing steps. In this way, both application operations can be optimized separately from each other.

Moreover, the proposed method allows the previously described customization step to be omitted essentially completely. This makes it possible to save, e.g., around 5-8 cents per label, which signifies a considerable saving at normal costs of radio-frequency labels of at least 50 cents per radio-frequency label.

Moreover, the omission of the customization step means that it is possible to avoid placing an additional load on the transponder, in particular on the sensitive radio-frequency chip. In this way, the rejection rate in production can be reduced, and the risk to the finished product can be greatly reduced.

In addition, with the separate application, cover labels can be used that do not necessarily have to meet the customization. This increases the range of usable adhesive labels, such that a large number of commercially available cover labels, for example with desired inscription properties, can be used.

In one embodiment, the at least one transponder and the at least one cover label are manufactured in different method steps, the transponder being fixed on the surface of the article in a first fixing step, and the cover label being fixed on the transponder in a subsequent second fixing step. This separation of the manufacturing steps increases the advantages described above and has in particular the effect that transponder and cover label can be optimized separately. In particular, the transponder, before and/or after the first fixing step, can undergo a transponder control step in which a check is made on whether the transponder is defective. For example, this transponder control step can take place after a dispensing of the transponder, that is to say after fixing of the transponder on the surface of the article. It is also possible for a transponder control step to take place before the dispensing or during the dispensing, which is intended to be covered by the wording “before and/or after”. Transponders identified as being defective may be discarded before a cover label is applied to these transponders or before these transponders are applied to the surface. A cover label can in particular be saved in this way, and, since the cover labels with their inscribable properties generally represent a considerable cost factor, this can in turn lead to a considerable reduction in the cost of the overall process.

As has been described above, the transponder itself can be obtained from an external supplier and produced completely by this supplier, for example a company specializing in a bonding process. The control of the transponder in the transponder control step can include various types of control, for example simple visual control (for example by means of an image analysis system that compares the visual appearance of the transponder with a default) and/or other controls can be used, for example electrical controls. These electrical controls can, for example, access the functions of the transponder and can, for example, involve contactless writing into the transponder and/or contactless reading out from the transponder.

Alternatively or in addition, the cover label, before and/or after the second fixing step (the wording “before and/or after” also including simultaneousness), analogously undergoes a label control step in which a check is made on whether the cover label is defective. Once again, cover labels identified as being defective can be discarded before these are able to be fixed on the transponder. In this way, if a cover label proves to be damaged or defective, the loss of a transponder is avoided, and cost savings can be made.

To fix the transponder on the surface of the article, the transponder can in particular have at least one first adhesive layer. This first adhesive layer can in particular have an acrylate adhesive having a thickness of between about 5-100 μm, for example around 20 μm. This adhesive layer can, for example, be applied with a large surface area over the inlay with the at least one antenna and the at least one radio-frequency chip and the remaining exposed carrier film. Thus, for example, a layered structure can be built up which, starting from the surface of the article, can have the following layer sequence: adhesive layer; antenna and radio-frequency chip; carrier film. In this way, a self-adhesive transponder label can be created, with an inlay directed towards the article.

In an alternative to the described layer sequence, a covering layer can also be provided which protects the inlay with the radio-frequency chip and the antenna and in particular covers the radio-frequency chip. The antenna too can be covered completely or partially by the covering layer. In this case, the above-described adhesive layer can be applied on that side of the covering layer directed away from the radio-frequency chip, such that the following layer sequence can be obtained: adhesive layer; covering layer; inlay with radio-frequency chip and antenna; carrier film. The covering layer can, for example, be a PET film (polyethylene terephthalate) or another plastic and/or paper material, or a combination of several layer materials. Other configurations are also conceivable, however.

As has been described above, the antenna can, for example, comprise a copper antenna, an aluminum antenna, a gold antenna, or an antenna produced from another metal. However, as has also been explained, a configuration using conductive polymers is also conceivable. The antenna can be applied or structured, for example, by means of an etching method, a printing method, a laminating method, a hot stamping method or another layering method or a combination of such methods.

To fix the cover label on the transponder, the cover label can have a second adhesive layer. This second adhesive layer can, for example, again have an acrylate adhesive. However, analogously to the first adhesive layer, it is once again also possible to use other types of adhesives or combinations of adhesives. The first adhesive layer and/or the second adhesive layer can be provided with a protective film, for example, such that transponder and/or cover label can each be produced, stored, handled, supplied and dispensed as a semi-finished product. The respective protective films can each be removed before the transponder is fixed on the surface and/or before the cover label is fixed on the transponder. The whole process can, for example, be carried out manually and/or can be automated or partially automated, for example in a rolling process.

To apply the cover labels to the transponders, a method step can in particular be used in which the cover label is first fixed on the transponder over a large surface area (i.e. not adapted to the size of the transponder). This can be done, for example, by several transponders being covered simultaneously by the large-surface cover label, for example several transponders fixed on several articles. The cover label can then be punched, such that the final shape of the cover label is obtained. This shape can be chosen, for example, such that this cover label in its lateral extent protrudes past the transponder. Alternatively, however, it would also be possible to have cover labels that are smaller than the transponder or that are the same size as the transponder. After the punching (which punching may, by analogy, also involve any other desired cutting process, for example laser cutting and/or mechanical cutting), the lattice resulting from the cover label is removed. Lattice removal is to be understood as an operation in which excess parts of the original large-surface cover label are removed from the article or articles. The name derives from the fact that, because the actual cover labels generally have a square shape or a rectangular shape, these excess parts have a lattice shape. In this way, the proposed process also allows a plurality of transponders to be provided simultaneously with cover labels, such that the proposed process is also highly suitable for large-scale production. In this respect also, the two-part configuration of the proposed method thus once again has a positive contribution, as this greatly simplifies the method and reduces the production costs.

An important aspect of the present invention is in particular the fact that the at least one cover label has at least one inscribable surface directed away from the carrier film. This inscribable surface ensures that the radio-frequency label is not simply able to be used electronically as a data memory, and instead, for example, information that can be discerned by the human eye or by another optical reading device can be applied to the surface of the cover label. For example, batch numbers, barcodes, type designations or similar information concerning the article or component parts of the article can be registered on the surface of the cover label.

In other embodiments, the inscribable surface can be inscribed by means of at least one of the following inscription methods: a laser inscription method, a laser printing method, a thermal transfer printing method, an inkjet printing method. Accordingly, the inscribable surface can have properties which are adapted to this inscription method and which are known to a person skilled in the art of these inscription techniques.

In other embodiments, a laser inscription method is used. The cover label, or the inscribable surface of the cover label, can thus have at least one laser-sensitive layer which is designed to change at least one optically discernible property when acted upon by a laser beam. This at least one optically discernible property can comprise one or more properties. In particular, the action of the laser beam can cause a color change, in particular a color change resulting from a thermochemical reaction and/or thermochromism in the laser-sensitive material, a removal of material involving removal of at least part of the laser-sensitive layer, an etching step in which at least part of the laser-sensitive layer is evaporated, or a combination of the stated and/or other optically discernible effects. If material removal effects are exploited in which part of the laser-sensitive layer is removed, the optical effect can be additionally enhanced if a colored layer (for example a black layer, a white layer and/or a multi-colored layer) lying below the partially removed layer is exposed by the laser action, such that the exposure can be observed by the human eye, for example. Laser-sensitive materials of this kind are known to a person skilled in the art of laser inscription. In one embodiment, the at least one laser-sensitive layer has a sensitivity at an infrared wavelength, for example a wavelength of about 10.6 μm (CO₂ laser) and/or 1064 nm (Nd:YAG). These wavelengths are particularly suitable for inscribing thermochemical materials, for example thermochromic materials, which undergo color reactions under the effect of infrared radiation. The infrared wavelengths can also be used to good effect in the stated material removal methods. In addition, lasers of this kind have been technically perfected and are available for use in large-scale technical production. The at least one laser-sensitive layer can have a layer thickness of between about 0.3 μm and about 10 μm, for example a layer thicknesses of about 2.5 μm. This range of layer thicknesses are suitable both for thermochromic inscriptions and also for inscriptions based on removal of material.

The cover label can also have at least one carrier layer with a covering material. This covering material can comprise, for example, a paper material and/or a plastic material. A multilayer structure is also conceivable.

In one embodiment, at least one depression is introduced into the surface of the article before the transponder is fixed on said surface of the article. This depression can be designed such that it receives the transponder completely or partially. In other embodiments, the depression is dimensioned in such a way that, after preparation of the radio-frequency label, the inscribable surface is substantially flat, that is to say, for example, only has irregularities in the range of less than 500 μm or, indeed, less than 100 μm. In this way, subsequent inscription of the inscribable surface is greatly simplified, such that simple inscribing devices can also be used. The at least one depression can be introduced at a later stage into the at least one article, for example by a mechanical method (e.g. a milling and/or cutting method), and/or can already be formed during production of the article. Thus, for example, articles can be made from plastic materials, such that the depression is already introduced into the surface during production. This can be achieved, for example, by suitable configuration of a tool for an injection molding process and/or another type of pressing operation.

As has been described above, the method according to the invention, in one of the illustrative embodiments, may be used for an article which has at least one test element for the detection of at least one analyte in a sample. For example, the article can be a package for such a test element. The test element can in particular be designed such that it changes at least one detectable property (e.g. an optical and/or electrochemical property) in the presence of the analyte that is to be detected. Such test elements are known, for example, from the field of medical diagnostics (e.g. blood sugar measurement). Such test elements can be present, for example, in the form of test strips and/or in the form of test tapes. Thus, for example, test element magazines, e.g. bar magazines, drum magazines and tape magazines, with one or more such test elements can be provided with a radio-frequency label by means of the method described above. One or more information items concerning the test elements can be written into this radio-frequency label. In particular, this can be batch information, that is to say information containing specifics of the test element or test elements. In this way, by reading out the test element, this batch information can be recovered and utilized, for example automatically, by an analysis device, which then uses the test elements. Other types of information concerning the test element or test elements can also be written in. For example, the expiry date, the intended use, the handling conditions, combinations of these types of information or other information can be written into the transponder.

In addition, the at least one inscribable surface can also be inscribed with optically discernible information, which can be done in an inscribing step, for example. This inscription can, for example, contain optically readable information concerning the test element or test elements, such as, once again, the expiry date, the nature of the test elements, etc. It is also possible to provide a barcode, which allows a barcode reader to read out batch information, for example. In one embodiment, the inscribing step for inscribing the inscribable surface and the writing step for writing information into the transponder are carried out at least approximately simultaneously. For this purpose, for example, a writing device can be used with which both the inscribing step and also the writing step are carried out. “Approximately simultaneously” is to be understood as also meaning a time overlap and also a slight time delay, such as by not more than a few seconds.

A device for the manufacture of a radio-frequency label on an article is also proposed, which device can perform the above-described method according to the invention, particularly in one or more of the described embodiments. As regards the possible configurations of the device, reference may largely be made to the above descriptions of the possible method variants.

The device has at least one transponder dispenser for fixing a transponder with at least one radio-frequency chip, with at least one antenna and with at least one carrier film on a surface of an article. The device also has at least one cover label dispenser which is designed to fix at least one cover label, with at least one inscribable surface directed away from the transponder, onto the transponder fixed on the surface of the article.

The device can also have at least one transponder control device in order to identify and, if appropriate, discard defective transponders. Moreover, it is also possible, either alternatively or in addition, to provide at least one label control device in order to identify and, if appropriate, discard defective cover labels.

Alternatively to or in addition to the above-described method and device in one of the embodiments shown, improvements are also generally proposed in the value chain involved in the manufacture of radio-frequency labels. As has been explained, the manufacture of radio-frequency labels generally involves one or more chip manufacturers producing the at least one radio-frequency chip while, independently of this, one or more antenna manufacturers produce and supply the at least one antenna. The at least one radio-frequency chip and the at least one antenna are then delivered to a third company, the so-called bonder, where the chip is bonded onto the antenna, i.e. connected to it in a suitably electrically conductive manner. As has been explained above, the at least one antenna can be mounted on the at least one carrier film, which considerably facilitates the handling of the antenna. This unit, which comprises the chip and the antenna connected electrically conductively to the latter, and which can already have the functional properties of an RFID transponder, is then sent to what is called a converter, which generally represents the fourth link in the value chain. At this converter, the antenna and the connected chip are provided with an inscribable adhesive label, thus creating the finished radio-frequency label.

As has been explained above, this conventional value chain is relatively complex. In a further aspect of the invention, it is therefore proposed that two or more of the steps in this value chain be combined. In particular, it is proposed that the bonder at the same time also takes over the role of the converter. In this way, after the chip has been bonded onto the antenna, the unit thus produced can be provided with an inscribable label within one and the same company. This can be done, for example, in one and the same production line, or also in different stations run by the same manufacturer.

Alternatively, the converter could also take over the role of the bonder and thus bond the supplied radio-frequency chip and the supplied antenna before providing these with an inscribable cover label.

In this way, by combining one or more steps of this value chain, considerable savings can be made. Moreover, the coordination work usually required for coordinating a large number of suppliers and their products is greatly reduced, since fewer parties are involved in the value chain and, consequently, the number of sizes to be adapted to one another is reduced.

In addition to the described steps of bonding and converting, which can be combined, other steps in the manufacture of the radio-frequency label can of course also be combined with one manufacturer. Thus, for example, the manufacture of the antenna and/or the manufacture of the chip can also take place at the same manufacturer, which can mean further savings.

The invention is to be explained in more detail by the following figures and examples.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 shows the structure of a radio-frequency label corresponding to the prior art.

FIG. 2 shows the structure of a radio-frequency label according to the embodiments of the present invention.

FIG. 3 shows an illustrative embodiment of a method according to the present invention for the manufacture of a radio-frequency label on an article.

FIG. 4 shows an illustrative embodiment of a device for the manufacture of a radio-frequency label on an article.

In order that the present invention may be more readily understood, reference is made to the following detailed descriptions and examples, which are intended to illustrate the present invention, but not limit the scope thereof.

### DETAILED DESCRIPTION OF EMBODIMENTS OF THE PRESENT INVENTION

The following descriptions of the embodiments are merely exemplary in nature and are in no way intended to limit the present invention or its application or uses.

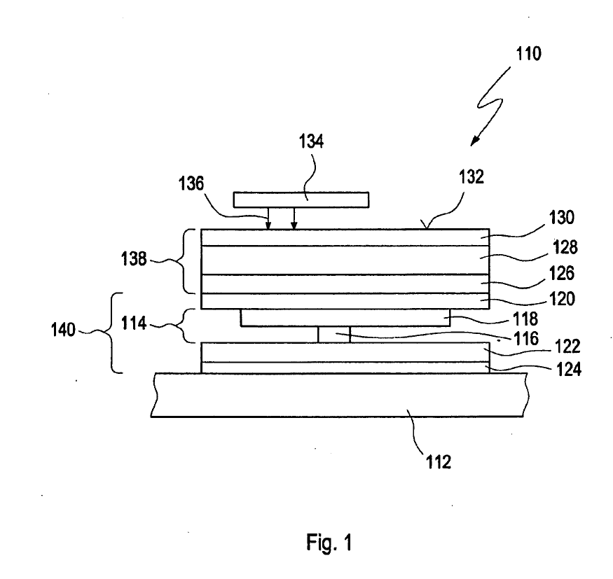

The structure of a radio-frequency label 110 corresponding to the prior art is shown schematically in FIG. 1. The radio-frequency label 110 in this illustrative embodiment is applied to the surface of an article 112 which, for example, can be a consumer item, a medical product or another article, for example from one of the abovementioned areas of use.

The central element of the radio-frequency label 110 is an inlay 114 which, in this illustrative embodiment, is composed of a radio-frequency chip 116 and an antenna 118. In addition, however, other component parts can also be provided. It is assumed hereinafter that the radio-frequency chip 116 is a conventional integrated circuit (IC) based on silicon technology. As has been described above, however, other technologies can also be used, for example, either alternatively or in addition, organic electronics, for example organic transistor circuits. The radio-frequency chip 116 is bonded onto the antenna 118 which, for example, can be an antenna made of a copper and/or aluminum material. In particular, the antenna 118 can have an antenna coil, which is typically mounted on a carrier film 120. This carrier film 120 can, for example, be a PET film, for example with a thickness of 30-40 μm.

On the side of the inlay 114 directed towards the article 112, the inlay 114 is covered by a covering layer 122. A first adhesive layer 124 can also be provided on that side of the first covering layer 122 directed towards the article 112, in order to fix the radio-frequency label 110 on the surface of the article 112. It will be noted, however, that other types of fixing are also conceivable, for example lamination, magnetic fixing, or other types of fixing.

Above the carrier film 120, and adjoining that side of the carrier film 120 directed away from the article 112, there is a second adhesive layer 126. The first adhesive layer 124 and the second adhesive layer 126 can both involve a layer of an acrylate adhesive. A carrier layer 128 in the form of a covering material is provided by the second adhesive layer 126. For example, it can be a PET film, for example a film with a thickness of ca. 50 μm.

Finally, a layer of a laser-sensitive material 130, for example with a thickness of 2.5 μm, is applied on the carrier layer 128. This laser-sensitive material 130 forms an inscribable surface 132 of the radio-frequency label 110, which surface can be inscribed by laser irradiation 136 by means of a laser 134. For example, this inscribing can be effected by initiating thermochromic effects in the laser-sensitive material 130, or it is possible, alternatively or in addition, for removal of the laser-sensitive material 130 to be performed by the laser irradiation 136, such that an optically discernible change occurs in the inscribable surface 132. For example, this optically discernible change can involve the laser-sensitive material 130 being completely removed locally by the laser irradiation 136, such that color differences between the laser-sensitive material 130 and the underlying carrier layer 128 can be discerned. For this purpose, the laser-sensitive material 130 and the carrier layer 128 can have different colors, or it is possible, alternatively or in addition, to insert an additional layer between the carrier layer 128 and the laser-sensitive material 130, for example a colored layer or a white layer, which forms a contrast to the color or shade of the laser-sensitive material 130.

In this structure, the second adhesive layer 126, the carrier layer 128 and the laser-sensitive material 130 together form a cover label 138, whereas the inlay 114, the carrier film 120, the covering layer 122 and the first adhesive layer 124 form a transponder 140. As has been described above, in conventional methods the radio-frequency label 110 is generally produced by different manufacturers, the transponder 140 and the cover label 138 generally being produced separately, then customized and, finally, being applied in the customized state to the article 112.

As has been described in the introduction, radio-frequency labels 110 according to the illustrative embodiment in FIG. 1 or similar illustrative embodiments are produced generally in a multi-stage process, with the involvement of numerous participants. Thus, the at least one radio-frequency chip 116 is usually produced by a chip manufacturer, and the antenna 118 by a separate antenna manufacturer. Both component parts 116, 118 are delivered separately to a third supplier, the so-called bonder, who bonds the radio-frequency chip 116 onto the antenna 118 and thus produces the inlay 114. This inlay is delivered as a separate unit to a fourth manufacturer in the value chain, namely a converter, which applies the carrier layer 128 and the laser-sensitive material 130, for example.

In an aspect of the invention that can be realized alternatively to or in addition to the below-described method steps of one particular embodiment, it is proposed that the value chain be simplified by combining various manufacturing steps. In particular, as has been set out above, the bonding and the converting can be combined, such that a bonder, for example, can also take over the converting, or a converter can take over the bonding. For example, a method could be configured such that an antenna manufacturer supplies the carrier film 120 as tape material with antennas 118 mounted thereon. A chip manufacturer supplies radio-frequency chips 116, which are delivered, for example, in the form of large semiconductor wafers with numerous radio-frequency chips 116 located thereon. The combined manufacturer now applies a radio-frequency chip 116 (if appropriate also several of them) to the unit composed of carrier film 120 and antenna 118 in one method step, for example by means of a pick-and-place method, with electrical contacting (bonding). The units bonded in this way can be provided, in a further method step, with the covering layer 122 and/or the first adhesive layer 124. In a further method step, the cover label 138 is applied, or it is possible for the inlay 114, if appropriate together with the carrier film 120 and/or the covering layer 122 and/or the first adhesive layer 124, to be applied to this cover label 138, which, technically, amounts at least approximately to the same thing.

The application of the cover label 138 can be performed, for example, by ready-made cover labels 138 being applied, or the cover label 138 can be applied as tape material, after which punching out and lattice removal can take place, in order to create the ready-shaped radio-frequency labels 110.

The method steps outlined can take place in separate installations belonging to one and the same manufacturer (bonder and/or converter), or one or more method steps, or even all the method steps, can also be combined in one in-line process.

It will further be noted that the sequence of the stated method steps can also be modified. For example, the cover labels 138 can be applied first, followed by application of the covering layer 122 and/or the first adhesive layer 124.

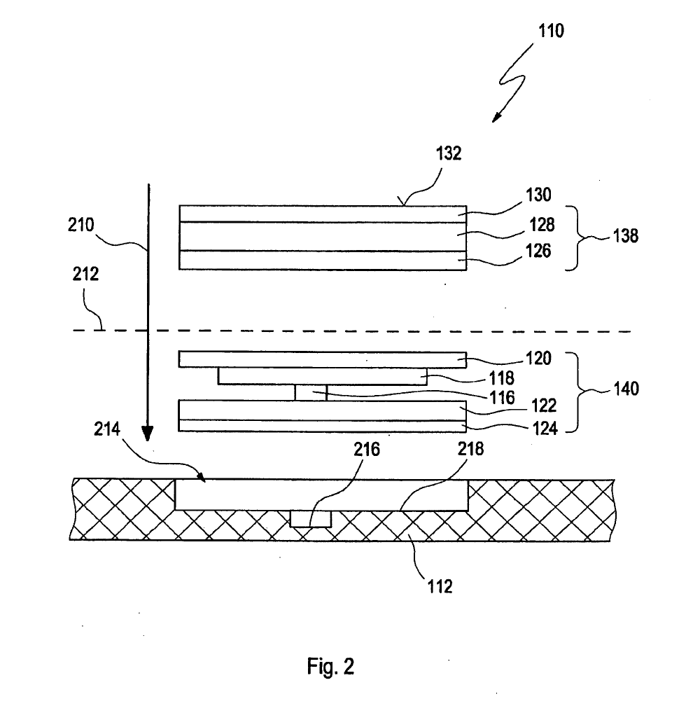

This method of simplification of the value chain in the manufacture of conventional radio-frequency labels 110 can be used alternatively to or in addition to the method according to the invention as described below with reference to FIGS. 2, 3 and 4. This logistical combining of functions in the value chain will not be explained in any more detail below.

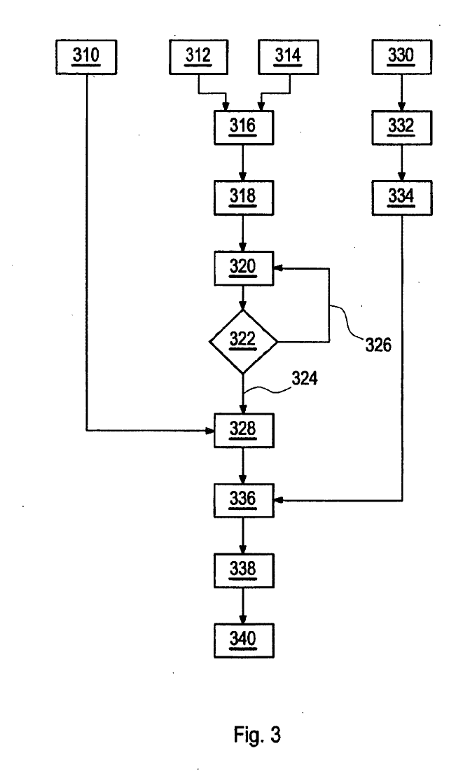

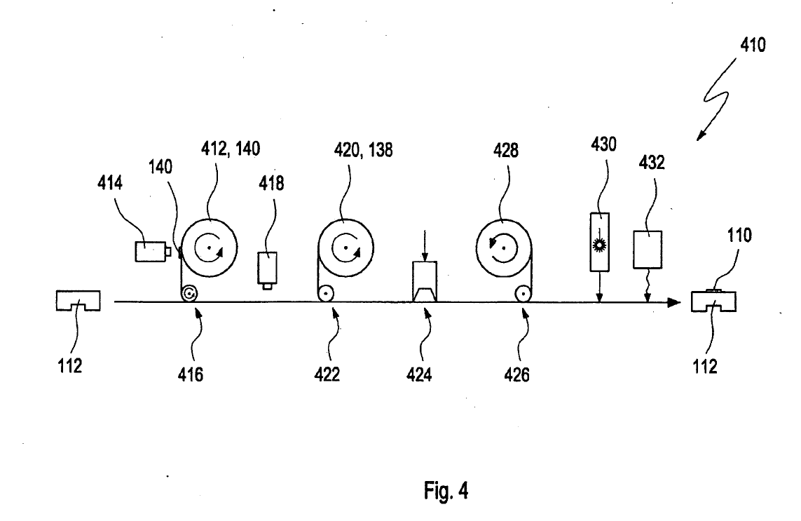

FIGS. 2 to 4 show an illustrative embodiment of a structure of a radio-frequency label 110 according to the invention (FIG. 2), an illustrative embodiment of a method for manufacture of the radio-frequency label 110 (FIG. 3), and a possible illustrative embodiment of a device for the manufacture of the radio-frequency label 110 (FIG. 4). These figures will be explained together hereinbelow.

It will be seen from FIG. 2 that, according to the invention, the radio-frequency label 110 is constructed in two parts, with a transponder 140 and a cover label 138 being applied separately to the surface of the article 112. The laminating direction is indicated symbolically by reference number 210, and the separation between application of the transponder 140 and application of the cover label 138 is indicated by reference number 212.

The transponder 140 and the cover label 138 can, for example, be structured analogously to the above description. The cover label 138 is configured by the second adhesive layer 126 as a self-adhesive cover label 138, which second adhesive layer can have a thickness of 20 μm, for example. The transponder 140 can also be configured by the first adhesive layer 124 as a self-adhesive transponder, it being possible once again to use an acrylate adhesive with a thickness of 20 μm, for example. For the other configurations of the individual components, reference may be made, for example, to the above description of FIG. 1.

In contrast to FIG. 1, the surface of the article 112 in FIG. 2 is provided with a depression 214, said article 112 being, for example, a cassette housing of a tape cassette for tape-like test elements for the detection of blood glucose. The depression 214 has a central cutout 216 which is dimensioned in such a way as to accommodate the radio-frequency chip 116, which is generally the bulkiest part of the transponder 140. The central cutout 216 is adjoined by a flat cutout 218 into which the other component parts of the transponder 140 can be received. The central cutout 216 has the effect that, when the transponder 140 is applied onto the surface of the article 112, the surface of the transponder 140 may be substantially flat. The covering layer 122 and the first adhesive layer 124 can in particular be made so thin and so flexible that they fit without any problem to the contour of the depression 214. The surface of the transponder 140 can end flush with the surface of the article 112 outside the depression 214, or, for example, the surface of the transponder 140 can be set further down than this surface of the article 112, such that it is only when the cover label 138 is applied that there is a surface flush with the surface of the article 112. Other configurations are also conceivable, however. The flat surface of the transponder 140 and/or of the cover label 138 facilitates the subsequent inscribing of the inscribable surface 132.

In the manufacture of the structure according to FIG. 2 or of a similar structure, it is possible, for example, to use the method depicted schematically in FIG. 3. The individual method steps do not necessarily have to be performed in the sequence illustrated, and it is possible to perform other method steps not shown in FIG. 3. Moreover, the defined sequence of the method steps according to FIG. 3 is not absolutely necessary, and it is possible, for example, for individual method steps or several method steps to be repeated, in parallel or in another sequence.

The method is basically divided into three parts, which can be brought together at different times. In a first branch of the method, the article 112 is manufactured (step 310). This method step 310 can also include the formation of the depression 214 in a surface of the article 112. In one embodiment, this depression can be formed at the same time as the manufacture of the article itself, for example by suitable configuration of an injection molding tool. For example, a large number of such articles 310 can be manufactured in a mass production process.

In a second branch of the method (shown in the middle in FIG. 3), the transponder 140 is manufactured and made available. The steps of this manufacture are shown in a greatly simplified manner in FIG. 3. Thus, this method comprises, for example, the manufacture of the radio-frequency chip 116 (step 312), manufacture of the antenna 118 (step 314), bonding of the radio-frequency chip 116 onto the antenna 118 with the carrier film 120 (step 316), and application of the covering layer 122 and of the first adhesive layer 124 (step 318).

The transponders 140 manufactured in method steps 312 to 318 can be made available as tape material, for example, and can be delivered to a labeling process. For this purpose, a defined transponder 140 is made available in method step 320. This transponder 140 can, for example, undergo a transponder control step 322, for example a visual check and/or an electrical check in accordance with the above description. Step 322 can, for example, include a query as to whether the transponder 140 is fault-free (branch 324 in FIG. 3), in which case the method is continued with the transponder that has been made available. By contrast, if the transponder 140 is defective (branch 326 in FIG. 3), the defective transponder 140 can be discarded and a new transponder made available (return to step 320).

With a fault-free transponder, step 328 then involves the transponder 140 being fixed to the surface of the article 112, for example in the depression 214 described above.

At the same time as or at different times from the method steps hitherto described, the cover label 138 is manufactured in a third branch of the method shown in FIG. 3. This manufacture, which is likewise shown in a greatly simplified manner in FIG. 3, can include, for example, the provision of the carrier layer 128 (step 330), application of the laser-sensitive material 130 (step 332), and application of the second adhesive layer 126 (step 334).

After method steps 330 to 334 have been performed, the cover labels 138 manufactured in this way can in turn be made available as tape material, for example, in order to be delivered to the labeling process.

In method step 336, the cover label 138 is fixed on the transponder 140. This is done, for example, by the cover label 138 being applied over a large surface area onto the transponder or transponders 140 fixed in method step 328. For example, a large-surface cover label 138 can be applied onto several transponders 140.

Thereafter, in method step 338, the cover label 138 or the cover labels 138 are punched out such that, for example, each cover label 138 substantially corresponds, in terms of its lateral extent, to a transponder 140.

The excess material of the original large-surface cover label 138 is not needed for covering a transponder 140 and is then cut off as a lattice in method step 340 and removed from the process.

FIG. 4 shows an illustrative embodiment of a device 410 which, for example, can be used to carry out the process illustrated in FIG. 3. The device 410 is based on the articles 112 (for example tape cassettes) being supplied already as finished or semi-finished products and being delivered to a process line. As has been described above, the transponders 140 can also be supplied as tape material 412 and delivered to the process according to FIG. 4.

The device has a transponder control device 414 for checking a transponder 140 that has been made available. If the transponder 140 is identified as being free of faults, it is applied to the article 112 or articles 112 in a transponder dispenser 416, which is only indicated symbolically in FIG. 4. Correct application and fixing can then optionally be checked in a control station 418.

It will be noted that the transponder dispenser 416 in FIG. 4 is only indicated symbolically as a roller device. Instead of such a laminating process by means of a roller-type labeling device, numerous other ways of applying a transponder 140 are also conceivable, however, for example pick-and-place methods or the like.

As has been described above, the cover labels 138 are also supplied as tape material 420 in the device 410 shown in FIG. 4 and delivered as such to the process. As with the transponders 140, however, a different method configuration is also conceivable in this respect, for example a pick-and-place method.

The cover labels are applied onto the articles 112 in a cover label dispenser 422, and, as has been explained above, they may be applied across a large surface area. The cover labels 138 can then be punched out in a punch 424. Excess material of the cover labels 138 can then be removed as a lattice in a lattice removal device 426 and delivered to a waste drum 428.

In this way, the articles 112, for example the tape cassettes, are labeled and the radio-frequency label 110 is produced on each article 112. The articles can be removed from the device 410. Alternatively or in addition, however, the device 410 can also comprise a laser inscriber 430, which for example comprises a CO₂ laser, and/or a read/write station 432 for writing information into the transponders 140. The laser inscriber 430 and the read/write station 432 can also be combined in a single appliance, for example.

It will be noted that FIG. 4 is merely a schematic representation of just one possible embodiment of the device 410. The individual component parts of the device 410 and their configuration are known to a person skilled in the art, for example a production engineer. Moreover, FIG. 4 shows a fully automated, continuous production sequence. However, it is also possible for several subsidiary methods to be carried out, for example in the context of a discontinuous process. Alternatively or in addition, it is also possible for some process steps to be carried out manually instead of using a fully automated process.

The features disclosed in the above description, the claims and the drawings may be important both individually and in any combination with one another for implementing the invention in its various embodiments.

It is noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the present invention in detail and by reference to specific embodiments thereof, it will be apparent that modification and variations are possible without departing from the scope of the present invention defined in the appended claims. More specifically, although some aspects of the present invention are identified herein as preferred or particularly advantageous, it is contemplated that the present invention is not necessarily limited to these preferred aspects of the present invention.

What is claimed is:

1. A method for manufacturing a radio-frequency label on an article, the method comprising the steps of: fixing at least one transponder on a surface of the article, the transponder having at least one radio-frequency chip and at least one antenna and at least one carrier film; and fixing at least one cover label on the transponder, the cover label having at least one inscribable surface directed away from the transponder.

2. The method according to claim 1, wherein the at least one transponder and the at least one cover label are manufactured in different method steps, the transponder being fixed on the surface of the article in a first fixing step, and the cover label being fixed on the transponder in a second fixing step.

3. The method according to claim 2, further comprising the step of checking the transponder to identify whether the transponder is defective.

4. The method according to claim 3, further comprising the step of discarding the transponder before a cover label is applied if the transponder is identified as being defective.

5. The method according to claim 2, further comprising the step of checking the cover label to identify whether the cover label is defective.

6. The method according to claim 5, further comprising the step of discarding the cover label before the cover label is fixed on the transponder if the cover label is identified as being defective.

7. The method according to claim 1, wherein the transponder comprises a first adhesive layer for fixing the transponder on the surface of the article.

8. The method according to claim 7, wherein the first adhesive layer comprises an acrylate adhesive.

9. The method according to claim 7, wherein the first adhesive layer has a thickness of between about 5 micrometers and about 100 micrometers.

10. The method according to claim 9, wherein the first adhesive layer has a thickness of about 20 micrometers.

11. The method according to claim 1, wherein the transponder comprises a covering layer for covering the radio-frequency chip.

12. The method according to claim 11, wherein the covering layer comprises a PET film.

13. The method according to claim 1, wherein the antenna comprises at least one of a copper antenna, an aluminum antenna, and a gold antenna.

14. The method according to claim 1, wherein the cover label comprises a first adhesive layer for fixing the cover label on the transponder.

15. The method according to claim 14, wherein which the first adhesive layer comprises an acrylate adhesive.

16. The method according to claim 1 wherein the cover label comprises a large-surface cover label, and further comprising the steps of punching the cover label after the step of fixing the cover label on the transponder, and removing the resulting lattice from the cover label.

17. The method according to claim 1, wherein the inscribable surface of the cover label is inscribed by at least one method selected from the group of methods consisting of a laser inscription method, a laser printing method, a thermal transfer printing method, and an inkjet printing method.

18. The method according to claim 1 wherein the cover label comprises at least one laser-sensitive layer configured to change at least one discernible property when acted upon by a laser beam.

19. The method according to claim 18, wherein the change to the at least one discernible property comprises at least one of a color change, a removal of at least part of the material of the laser-sensitive layer, and evaporation by etching.

20. The method according to claim 19, wherein the change comprises at least a color change resulting from at least one of a thermochemical and thermochromic reaction.

21. The method according to claim 18, wherein the laser-sensitive layer comprises laser sensitivity to at least one laser wavelength from between about 1064 nm and about 10.6 μm.

22. The method according to claim 18, wherein the laser-sensitive layer comprises at least one thermochemical material.

23. The method according to claim 22 wherein the thermochemical material comprises a thermochromic material.

24. The method according to claim 18 wherein the laser-sensitive layer comprises a layer thickness from between about 0.3 micrometer to about 10 micrometers.

25. The method according to claim 24 wherein the layer thickness is about 2.5 micrometers.

26. The method according to claim 1, wherein the cover label comprises at least one covering material as carrier layer, the covering material comprising at least one of a paper material, a plastic material, and a PET material.

27. The method according to claim 1, further comprising the step of introducing at least one depression into the surface of the article before the step of fixing the transponder on the surface, wherein the depression is configured to at least partially receive the transponder.

28. The method according to claim 27, wherein the depression is dimensioned such that the inscribable surface is substantially flat.

29. The method according to claim 1, wherein the article comprises at least one package for at least one test element configured for the detection of at least one analyte in a sample, the test element being designed to change at least one detectable property thereof in the presence of the analyte.

30. The method according to claim 29, further comprising a step of writing at least one information item into the transponder, the at least one information item comprising at least one information item concerning the at least one test element.

31. The method according to claim 30, further comprising a step of inscribing optically discernible information into the inscribable surface.

32. The method according to claim 31, wherein the inscribing step and the writing step are carried out at least approximately simultaneously.

33. A device for manufacturing a radio-frequency label on an article, the device comprising at least one transponder dispenser configured for fixing a transponder with at least one radio-frequency chip, with at least one antenna and with at least one carrier film on a surface of an article, the device further comprising at least one cover label dispenser configured to fix at least one cover label onto the transponder fixed on the surface of the article, the cover label comprising at least one inscribable surface directed away from the transponder.

34. The device according to claim 33, further comprising at least one transponder control device configured to identify and discard defective transponders.

35. The device according to claim 33, further comprising at least one label control device in order to identify and discard defective cover labels.
